(19) United States
(12) Patent Application Publication
(10) Pub. No.: US 2007/0258419 A1
(43) Pub. Date: Nov. 8, 2007

(54) Network adaptive priority management in wireless local area networks

(75) Inventors: Yun Zhao, San Mateo, CA (US); Clifford Tavares, San Diego, CA (US)

Correspondence Address: THELEN REID BROWN RAYSMAN & STEINER LLP, 2225 EAST BAYSHORE ROAD, SUITE 210, PALO ALTO, CA, 94303, US

(73) Assignee: Hitachi, Ltd.

(21) Appl. No.: 11/429,028

(22) Filed: May 4, 2006

(51) Int. Cl. H04Q 7/24

(52) U.S. Cl. 370/338

(57) ABSTRACT

A method comprises determining whether there is an unused access category higher than a pending access category in a wireless network; and upgrading the pending access category to use at least one MAC layer parameter, e.g., an EDCA parameter, of the higher access category. The method may determine whether an entering access category is higher than the pending access category, and if so then downgrading the pending access category. The downgrading may return the pending access category back to its default access category. The method may determine whether the entering access category is the same as the pending access category, and if so then maintaining the access categories as upgraded. The method may further comprise determining whether the entering access category is lower than the pending access category, and if so then maintaining the access categories as upgraded or upgrading the entering access category to the highest unused access category.

### TECHNICAL FIELD

This invention relates generally to wireless networks, and more particularly provides adaptive priority management in wireless local area networks.

### BACKGROUND

As users experience the convenience of wireless connectivity, they are demanding increasing support. Typical applications over wireless networks address include video streaming, video conferencing, distance learning, etc. Because wireless bandwidth availability is restricted, quality of service (QoS) management is increasingly important in 802.11 networks. IEEE 802.11e proposes to define QoS mechanisms for wireless gear that gives support to bandwidth-sensitive applications such as voice and video.

The original 802.11 media access control (MAC) protocol was designed with two modes of communication for wireless stations. The first mode, Distributed Coordination Function (DCF), is based on Carrier Sense Multiple Access with Collision Avoidance (CSMA/CA), sometimes referred to as “listen before talk.” A station waits for a quiet period on the network and then begins to transmit data and detect collisions. The second mode, Point Coordination Function (PCF), supports time-sensitive traffic flows. Wireless access points periodically send beacon frames to communicate network identification and management parameters specific to the wireless network. Between sending beacon frames, PCF splits the time into a contention-free period and a contention period. A station using PCF transmits data during contention-free periods.

Because DCF and PCF do not differentiate between traffic types or sources, IEEE proposed enhancements to both coordination modes to facilitate QoS. These changes are intended to fulfill critical service requirements while maintaining backward-compatibility with current 802.11 standards.

Enhanced Distribution Coordination Access (EDCA) introduces the concept of traffic categories. Using EDCA, stations try to send data after detecting that the medium is idle for a set time period defined by the corresponding traffic category. A higher-priority traffic category will have a shorter wait time than a lower-priority traffic category. While no guarantees of service are provided, EDCA establishes a probabilistic priority mechanism to allocate bandwidth based on traffic categories.

The IEEE 802.11e EDCA standard provides QoS differentiation by grouping traffic into four access classes (ACs), i.e. voice, video, best effort and background. Each frame from the upper layers bears a priority value (0-7), which is passed down to the MAC layer. Based on the priority value, the frames are mapped into the four ACs at the MAC layer. The voice AC has the highest priority; the video AC has the second highest priority; the best effort AC has the third highest priority; and the background AC has the lowest priority. Each AC has its own transmission queue and its own set of medium access parameters. Traffic prioritization uses the medium access parameters—AIFS interval, contention window (CW), and transfer opportunity (TXOP)—to ensure that a higher priority AC has relatively more medium access opportunity than a lower priority AC.

Generally, the arbitration interframe space (AIFS) is the time interval that a station must sense the medium to be idle before invoking a backoff or transmission. A higher priority AC uses a smaller AIFS interval. The contention window (CW, CWmin and CWmax) indicates the number of backoff time slots until the station can access the medium. CW starts from CWmin and doubles every time a transmission fails until it reaches its maximum value CWmax. Then, CW holds its maximum value until the transmission exceeds its retry limit. A higher priority AC uses smaller CWmin and CWmax. The Transmission Opportunity (TXOP) indicates the maximum duration that an AC can be allowed to transmit frames after acquiring access to the medium. To save contention overhead, multiple frames can be transmitted within one acquired TXOP without any additional contention, as long as the total transmission time does not exceed the TXOP duration.

To reduce the probability of two stations colliding, because the two stations cannot hear each other, the standard defines a virtual carrier sense mechanism. Before a station initiates a transaction, the station first transmits a short control packet called RTS (Request To Send), which includes the source address, the destination address and the duration of the upcoming transaction (i.e. the data packet and the respective ACK). Then, the destination station responds (if the medium is free) with a response control packet called CTS (Clear to Send), which includes the same duration information. All stations receiving either the RTS and/or the CTS set a virtual carrier sense indicator, i.e., the network allocation vector (NAV), for the given duration, and use the NAV together with the physical carrier sense when sensing the medium. This mechanism reduces the probability of a collision in the receiver area by a station that is “hidden” from the transmitter station to the short duration of the RTS transmission, because the station hears the CTS and “reserves” the medium as busy until the end of the transaction. The duration information in the RTS also protects the transmitter area from collisions during the ACK from stations that are out of range of the acknowledging station. Due to the fact that the RTS and CTS are short frames, the mechanism reduces the overhead of collisions, since these frames are recognized more quickly than if the whole data packet was to be transmitted (assuming the data packet is bigger than RTS). The standard allows for short data packets, i.e., those shorter than an RTS Threshold, to be transmitted without the RTS/CTS transaction.

With these medium access parameters, EDCA works in the following manner: Before a transmitting station can initiate any transmission, the transmitting station must first sense the channel idle (physically and virtually) for at least an AIFS time interval. If the channel is idle after the AIFS interval, the transmitting station invokes a backoff procedure using a backoff counter to count down a random number of backoff time slots. The transmitting station decrements the backoff counter by one as long as the channel is sensed to be idle. Once the backoff counter reaches zero, the transmitting station initiates an RTS transmission and awaits a CTS transmission from the receiving station. If the transmitting station receives a CTS transmission from the receiving station, the transmitting station initiates the transaction. The station can initiate multiple frame transmissions without additional contention as long as the total transmission time does not exceed the TXOP duration.

If the transmitting station senses the channel to be busy at any time during the backoff procedure, the transmitting station suspends its current backoff procedure and freezes its backoff counter until the channel is sensed to be idle for an AIFS interval again. Then, if the channel is still idle, the transmitting station resumes decrementing its remaining backoff counter. After each unsuccessful transmission, CW doubles until CWmax. After a successful transmission, CW to CWmin. The level of QoS control for each AC is determined by the combination of the medium access parameters and the number of competing stations in the network.

The default EDCA parameter values used by non-AP QoS stations (QSTAs) are identified in the table below. A TXOP_Limit value of 0 indicates that a single MAC service data unit (MSDU) or MAC protocol data unit (MPDU), in addition to a possible RTS/CTS exchange or CTS to itself, may be transmitted at any rate for each TXOP.

TABLE
Default EDCA Parameter Set

| | | | | TXOP_Limit (ms) |
|---|---|---|---|---|
| AC | CWₘᵢₙ | CWₘₐₓ | AIFSN | for 802.11 g PHY |
| (0) | 31 | 1023 | 7 | 0 |
| AC_BK | | | | |
| (1) | 31 | 1023 | 3 | 0 |
| AC_BE | | | | |
| (2) | 15 | 31 | 2 | 3.008 |
| AC_VI | | | | |
| (3) | 7 | 15 | 2 | 1.504 |
| AC_VO | | | | |

Although 802.11e enhances the original 802.11 media access control, there are still a number of remaining challenges that need to be addressed to provide comprehensive QoS support. For example, the default EDCA parameters assigned to the different ACs are not suitable for time-varying network traffic. For example, if there is no higher priority traffic, keeping lower priority traffic in the lower priority AC is inefficient in terms of network bandwidth utilization. Accordingly, a system and method for increasing QoS support in wireless LANs, especially for time-varying network traffic, are needed.

### SUMMARY

According to one embodiment of the present invention, a method comprises determining whether there is an unused access category higher than a pending access category in a wireless network; and upgrading the pending access category to use at least one MAC layer parameter of the higher access category. The MAC layer parameter may include a contention-based EDCA parameter. The MAC layer parameter may include a transmission-based EDCA parameter. The unused access category may be the highest available access category currently unused. The wireless network may include at least two pending access categories and the upgrading may not modify the hierarchy of the at least two pending access categories. The method may further comprise determining whether an entering access category is higher than the pending access category; and if the entering access category is higher than the pending access category, then downgrading the pending access category to use the at least one MAC layer parameter lower than the entering access category. The upgrading may be implemented by modifying an EDCA parameter in the pending access category. The upgrading may be implemented by modifying a pointer in the pending access category. The determining and the upgrading may be performed by an access point. The determining may be performed by an access point, and the upgrading may be performed by a station.

In accordance with another embodiment of the present invention, a system comprises a priority management module for determining whether there is an unused access category higher than a pending access category in a wireless network; and an adaptive MAC layer module for upgrading the pending access category to use at least one MAC layer parameter of the higher access category. The MAC layer parameter may include a contention-based EDCA parameter. The MAC layer parameter may include a transmission-based EDCA parameter. The unused access category may be the highest available access category currently unused. The wireless network may include at least two pending access categories and the priority management module may not modify the hierarchy of the at least two pending access categories. The priority management module may determine whether an entering access category is higher than the pending access category; and the adaptive MAC layer module may downgrade the pending access category to use the at least one MAC layer parameter lower than the entering access category if the entering access category is higher than the pending access category. The adaptive MAC layer module may modify an EDCA parameter in the pending access category. The adaptive MAC layer module may modify a pointer in the pending access category. The priority management module and adaptive MAC layer module may be in an access point. The priority management module may be in an access point and the adaptive MAC layer module may be in a station.

According to yet another embodiment of the present invention, a system comprises means for determining whether there is an unused access category higher than a pending access category in a wireless network; and means for upgrading the pending access category to use at least one MAC layer parameter of the higher access category.

According to another embodiment of the present invention, a method comprises determining whether there is an unused access category higher than-a pending access category in a wireless network; upgrading the first pending access category to the higher access category; determining whether an entering access category entering the wireless network is higher than the pending access category; and if the entering access category is determined as higher than the pending access category, then downgrading the pending access category to an access category lower than the entering access category. The downgrading may include downgrading the pending access category back to its default access category. The method may further comprise determining whether the entering access category is the same as the pending access category; and if the entering access category is determined to be the same as the pending access category, then maintaining the access categories as upgraded. The method may further comprise determining whether the entering access category is lower than the pending access category; and if the entering access category is determined to be lower than the pending access category, then maintaining the access categories as upgraded. The method may further comprise determining whether the entering access category is lower than the pending access category; and if the entering access category is determined to be lower than the pending access category, then upgrading the entering access category to the highest unused access category. In one embodiment, where at least two different pending access categories are pending in the network, the method may further comprise determining whether one of the two pending access categories has left the network; if one of the pending access categories has left the network, then determining whether the access category now unused is higher than any pending access category; and if one of the access category now unused is determined to be higher than one of the pending access categories, then upgrading the one pending access category.

### BRIEF DESCRIPTION OF THE DRAWINGS

FIG. 1 is a block diagram illustrating a wireless network architecture, in accordance with an embodiment of the present invention.

FIG. 2 is a block diagram illustrating details of an access point of FIG. 1.

FIG. 3 is a block diagram illustrating details of a station of FIG. 1.

FIG. 4 is a block diagram illustrating details of an adaptive contention module of FIGS. 2 and 3.

FIG. 5A is an example adaptive shifting algorithm for a complex-drop shifting embodiment.

FIG. 5B is a timing diagram for the example adaptive shifting algorithm of FIG. 5A.

FIG. 6A is an example adaptive shifting algorithm for a default-drop shifting embodiment.

FIG. 6B is a timing diagram for the example adaptive shifting algorithm of FIG. 6A.

FIG. 7 is a flowchart illustrating an example upgrade method in accordance with an embodiment of the present invention.

FIG. 8 is a flowchart illustrating an example downgrade method in accordance with a default-drop shifting embodiment.

FIG. 9 is a block diagram illustrating details of a computer system.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

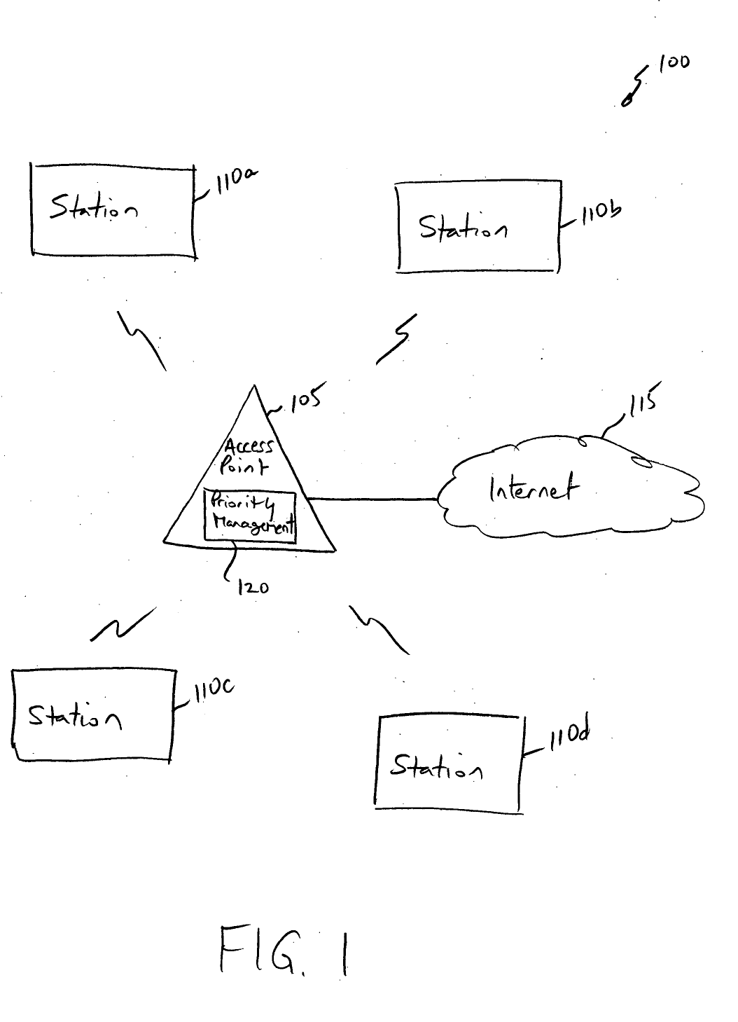

FIG. 1 is a block diagram illustrating a wireless network architecture 100, in accordance with an embodiment of the present invention. Wireless network architecture 100 includes an access point 105 coupled to a plurality of stations 110a-110d (each generally referred to as “station 110”). The access point 105 may be connected (wired or wirelessly) to the wide area network commonly referred to as the internet 115. The access point 105 includes a priority management module 120 that monitors traffic on the wireless medium (uplink and downlink) and manages contention priorities of the various access categories in its hot zone. The access point 105 may be capable of translating between wired (e.g., 802.3) and wireless (e.g., 802.11e) protocols.

Generally, the priority management module 120 operates to adjust traffic priority based on observed network traffic. In one embodiment, the priority management module 120 determines if there is unused higher priority traffic categories above or between pending (or anticipated) lower priority traffic categories. If so, the priority management module 120 upgrades the pending lower priority traffic categories to the highest priority traffic categories currently unused, while maintaining the hierarchical relationship of access categories. For convenience herein, the term “original” as in “original access category” refers to the default access category of a pending (or anticipated) access category. The term “adapted” as in “adapted access category” refers to the upgraded access category of a pending (or anticipated) access category.

When the priority management module 120 determines that new traffic has entered or is entering the zone during a period of priority adaptation, the priority management module 120 may determine whether priority adjustment is needed. If newly entering traffic is of a higher original access category than the original access categories of pending traffic, then the priority management module 120 may downgrade the priority/priorities of the adapted traffic categories as needed. In one embodiment, the priority management module 120 may return the priority/priorities of all pending access categories to the defaults assigned in the 802.11e standard. Similarly, when the priority management module 120 determines that an access category is leaving the network, the priority management module 120 can adjust the access categories to take into account the access category now available.

In one embodiment, the priority management module 120 adjusts traffic categories by broadcasting new traffic priority EDCA parameters to the stations 110, to modify the traffic priority EDCA parameters in the access categories of the MAC layer. Substantially concurrently, the access point 105 can modify its own traffic priority EDCA parameters. In another embodiment, the access point 105 may only modify its own parameters. In yet another embodiment, the priority management module 120 broadcasts access category EDCA parameter pointers to adjust the pointers in each access category in the MAC layer of each station, instead of modifying the EDCA parameters themselves. That way, a lower original access category accesses the EDCA parameters of a higher access category. In another embodiment, both modification of the EDCA parameters and access category EDCA parameter pointers can be implemented. In one embodiment, the access category may only utilize the EDCA parameters for contention (e.g., AIFS and CW), and not the EDCA parameters for transmission (e.g., TXOP). In another embodiment, the access category as adapted may utilize all EDCA parameters for the adapted access category. In either case, modification of the EDCA parameters may be additionally implemented. For example, if transmission-based EDCA parameters are utilized by the adapted access categories, the TXOP parameter in AC_VI may be optionally reduced.

According to one example, if there are AC_BE and AC_VI traffic in the network, the access point 105 may upgrade the AC_VI to AC_VO and upgrade the AC_BE to AC_VI. If an original AC_VI enters the network, then the access point 105 may adjust the access categories to re-prioritize the traffic according to the proper hierarchy of prioritization. Various upgrade and downgrade algorithms are possible.

Because traffic associated with a higher priority access category will gain channel access easier, network bandwidth utilization may be more efficient. QoS performance may improve. Because the access category determines network conditions, the access category can avoid conflict among the stations.

For example, the network adaptive priority management algorithms described herein may be used in a home or a public wireless network, where high data rate, time-sensitive video-stream applications, audio transmissions, Voice IP and best effort data traffic are deployed.

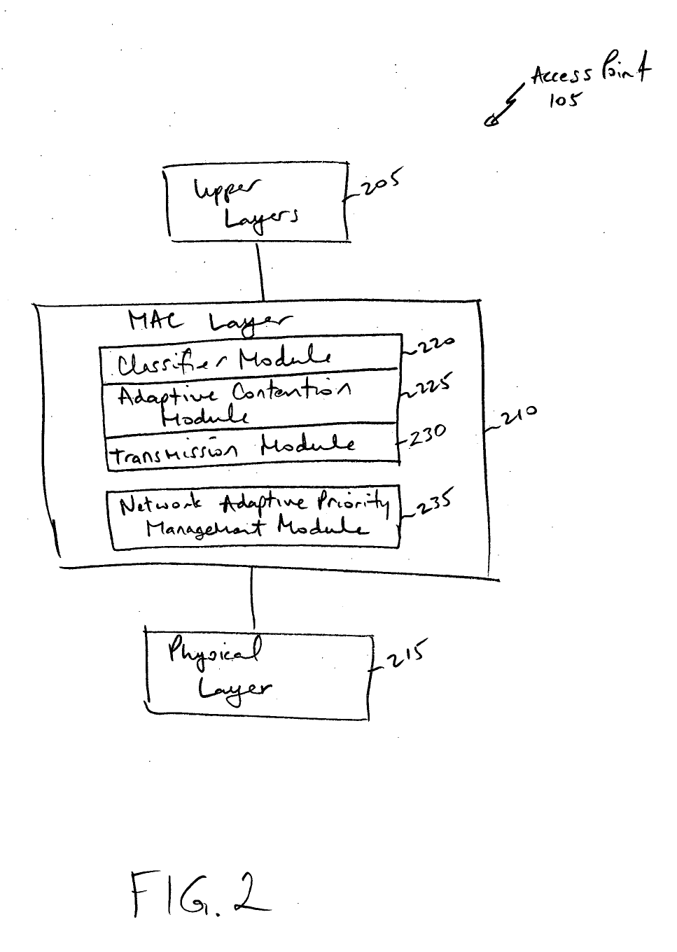

FIG. 2 is a block diagram illustrating details of an access point 105 of FIG. 1. The access point 105 includes upper layers 205, a MAC layer 210 and a physical layer 215. The MAC layer 210 includes a classifier module 220, an adaptive contention module 225 and a transmission module 230. The MAC layer 210 of the access point 105 also includes a network adaptive priority management module 235, which may be an instance of the priority management module 120 of FIG. 1.

During transmission of data frames, the upper layers 205 append priority bits into the frame header. The classifier module 220 of the MAC layer 210 reviews the priority bits to classify the data frame into the proper access category. The adaptive contention module 225 includes the four access categories, which utilize EDCA parameters to contend for access to the wireless medium. Upon gaining use of the wireless medium, the adaptive contention module 225 instructs the transmission module 230 to forward the information for transmission to the physical layer 215, which transmits the data frame onto the wireless medium.

The network adaptive priority management module 235 in the access point 105 monitors its access category queues in the adaptive contention module 225 and monitors traffic on the wireless medium. By monitoring the access category queues and the wireless medium traffic, the network adaptive priority management module 235 can determine which traffic categories are being used (and thus which are likely not being used). Using this information, the network adaptive priority management module 120 can adjust the EDCA parameters and/or pointers used by the pending traffic categories of the access point 105 and/or can broadcast an instruction to the stations 110 to adjust the EDCA parameters and/or pointers used by the pending traffic categories of the stations 110.

It should be noted that uplink traffic from the stations 110 to the access point 105 may not be recognized by the network adaptive priority management module 235 until at least one time slot in the future. Accordingly, in some embodiments, at times, higher priority uplink traffic may contend for access to the wireless medium with traffic in access categories originally of lower priority but adapted to the same or a higher priority access category. For example, if only AC_BK is pending on the network, the access point 105 may upgrade it to AC_VO. If a station 110 wishes to send traffic of the access category AC_VI, then the access point 105 sending the AC_BK traffic (adapted to AC_VO) will use EDCA parameters of higher priority than the entering AC_VI traffic. After the station 110 wins access to the wireless medium, the access point 105 will be notified of the AC_VI traffic. Accordingly, the access point 105 will downgrade the AC_BK traffic to a position below the AC_VI traffic, whether downgraded to its default position or to a lower adapted position. The access point 105 will anticipate that the station 110 will continue to send AC_VI traffic for a period of time thereafter, maintaining the AC_VI traffic as adapted higher than the AC_BK traffic as adapted. Then, if no AC_VI traffic continues, the access point 105 may upgrade the AC_BK traffic above the previously anticipated AC_VI traffic. For convenience herein, the term “pending” as in “pending traffic” includes traffic pending at the access point 105 and anticipated traffic.

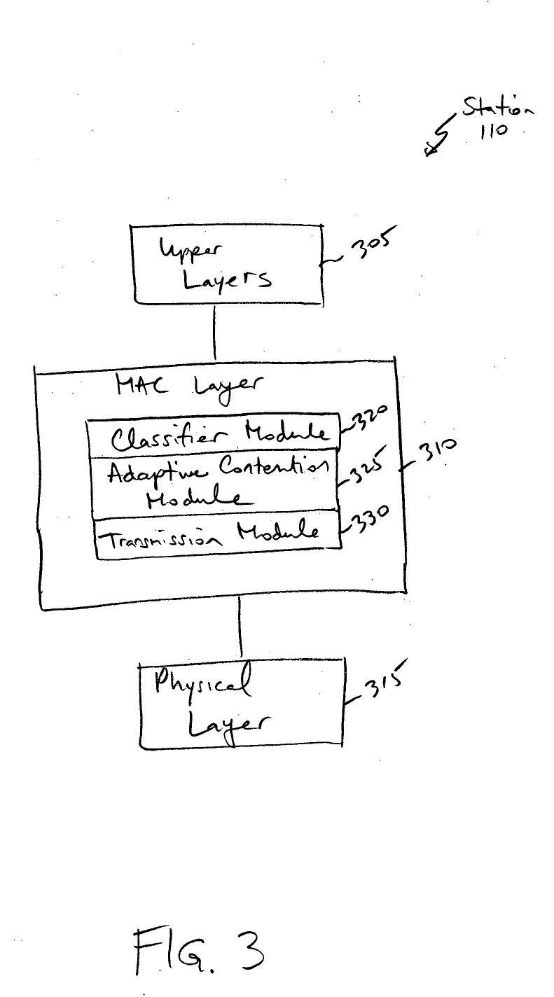

FIG. 3 is a block diagram illustrating details of a station 110 of FIG. 1. Similar to the access point 105, the station 110 includes upper layers 305, a MAC layer 310 and a physical layer 315. The MAC layer 310 includes a classifier module 320, an adaptive contention module 325 and a transmission module 330.

During transmission of data frames, the upper layers 305 append priority bits into the frame header. The classifier module 320 of the MAC layer 310 reviews the priority bits to classify the data frame into the proper access category. The adaptive contention module 325 includes the four access categories, which utilize EDCA parameters to contend for access to the wireless medium. Upon gaining use of the wireless medium, the adaptive contention module 325 instructs the transmission module 330 to forward the information for transmission to the physical layer 315, which transmits the data frame onto the wireless medium.

The adaptive contention module 325 monitors parameter adjustment instructions from the network adaptive priority management module 235 of the access point 105. The instructions may request adjustment of the EDCA parameters themselves and/or may request adjustment of the EDCA parameter pointers of each traffic category. The adaptive contention module 325 will respond accordingly.

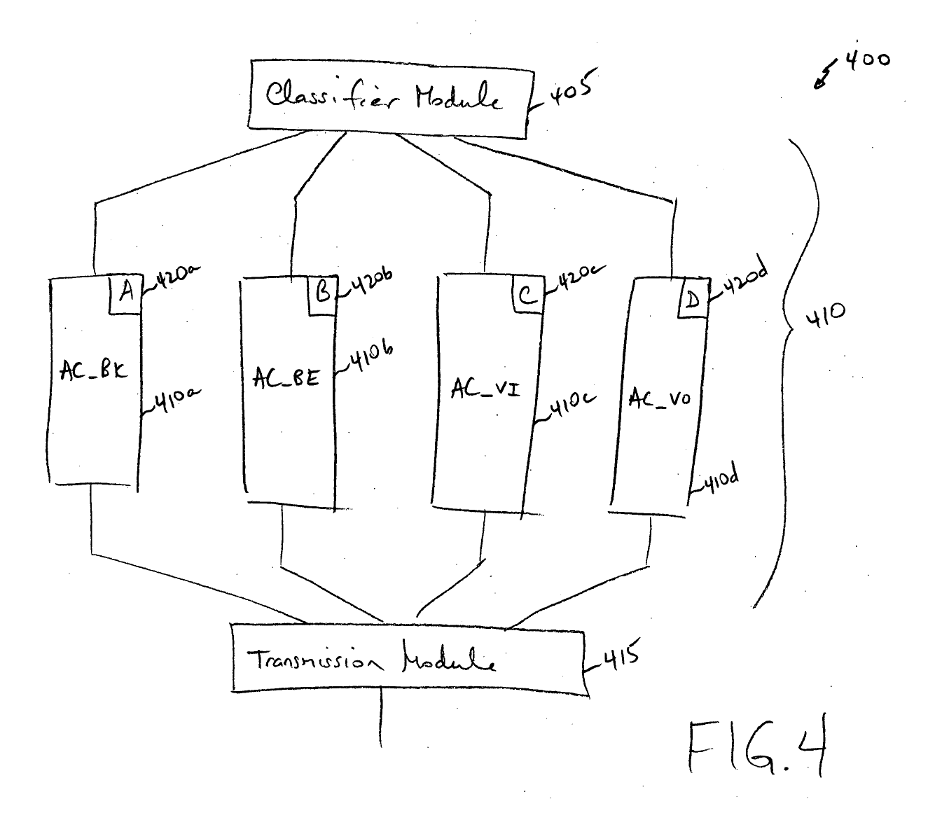

FIG. 4 is a block diagram illustrating details of a MAC layer 400, in accordance with an embodiment of the-present invention. MAC layer 400 includes a classifier 405, an adaptive contention module 410, and a transmission module 415. The adaptive contention module 410 may be an instance of the adaptive contention module 225 or adaptive contention module 325. The adaptive contention module 410 includes four access categories, namely, the background access category (AC_BK) 410a, the best-effort access category (AC_BE) 410b, the video access category (AC_VI) 410c, and the voice access category (AC_VO) 410d. In this embodiment, each of the access categories 410a-410d includes a pointer to the EDCA parameters to use for wireless medium contention. In default mode, pointer 420a points to EDCA parameters for AC_BK (i.e., A=0), pointer 420b points to EDCA parameters for AC_BE (i.e., B=1), pointer 420c points to EDCA parameters for AC_VI (i.e., C=2), and pointer 420d points to EDCA parameters for AC_VO (i.e., D=3). In one embodiment, each of the pointers 420a-420d is modified dynamically in response to instructions from the network adaptive priority management module 235. That way, for example, if there is no AC_VO or AC_VI traffic, the AC_BE traffic category can be modified to point to the EDCA parameters for AC_VO (i.e., B=3) and the AC_BK traffic category can be modified to point to the EDCA parameters for AC_VI (i.e., A=2).

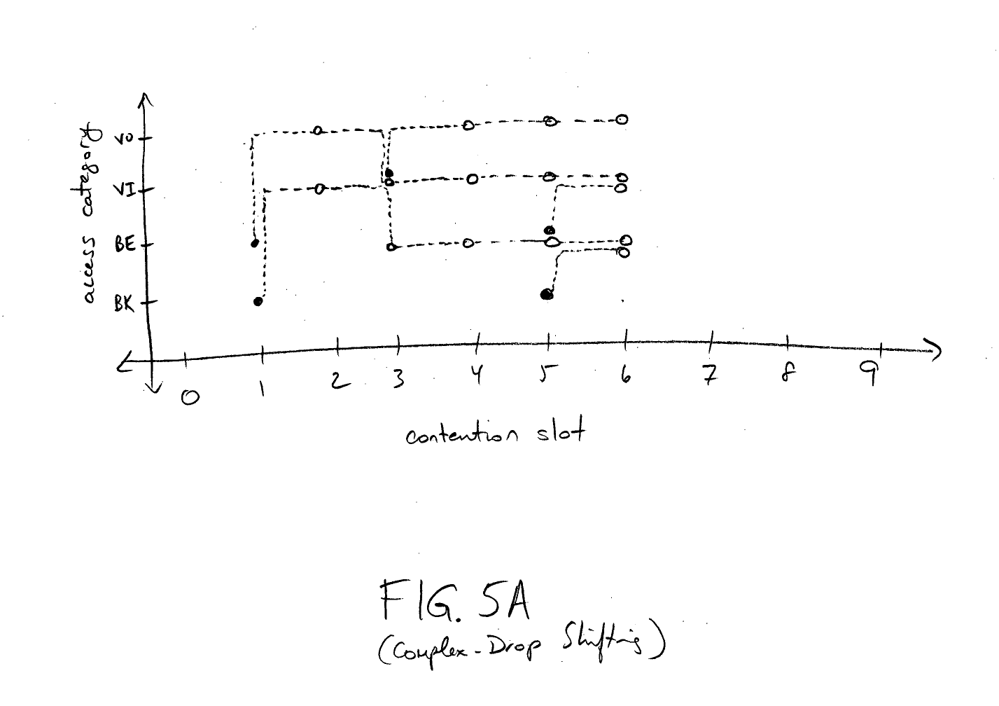

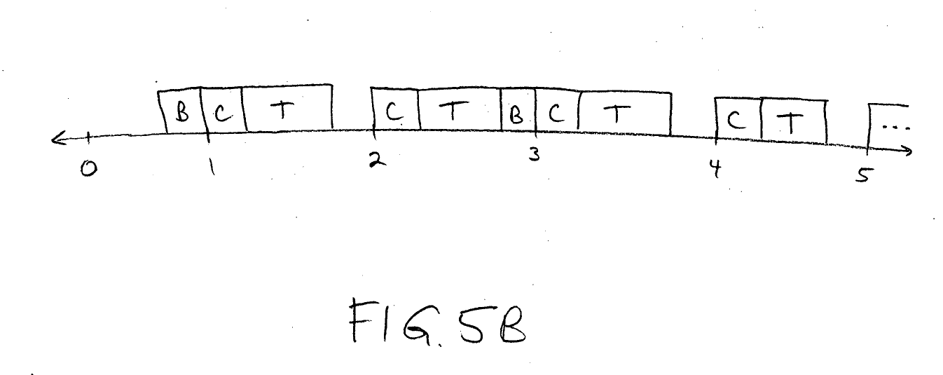

FIG. 5A is an example adaptive shifting algorithm for a complex-drop shifting embodiment. According to this example, at time slot 1, the access point 105 is aware of only AC_BK and AC_BE traffic pending. Accordingly, the access point 105 sends instructions to upgrade AC_BE to AC_VO and AC_BK to AC_VI. At time slot 2, no other traffic categories enter or leave the network. Accordingly, traffic categories as adapted stay the same. At time slot 3, AC_VI enters the network. Since AC_VI is higher priority than original AC_BK and AC_BE, the access point 105 upgrades AC_VI to AC_VO, downgrades original AC_BE (adapted to AC_VO) to AC_VI, and downgrades original AC_BK (adapted to AC_VI) to AC_BE. At time slot 4, no traffic categories enter or leave the network. Accordingly, traffic categories as adapted stay the same. At time slot 5, another original AC_BK and original AC_BE enter the network. Since these categories include the same priorities as other access categories already present, no access category change is needed. AC_BE remains adapted to AC_VI, and AC_BK remains adapted to AC_BE.

It should be noted that the example of FIG. 5A is based on traffic as noted and/or anticipated by the access point 105. As stated above, downlink traffic is noted by the access point 105 immediately. However, uplink traffic from the stations 110 to the access point 105 may not be recognized by the access point 105 until at least one time slot in the future. Accordingly, FIG. 5A is written from the perspective of the access point 105.

FIG. 5B is a timing diagram for a portion of the example adaptive shifting algorithm of FIG. 5A. According to the diagram, right before slot 1, the access point 105 sends a beacon frame (“B”) to the stations 110 (and possibly to itself) to adjust access categories. During time slot 1, the stations 110 and access point 105 contend (“C”) for the wireless medium using the adapted access categories. Then, the winning station 110 or access point 105 sends a transmission (“T”). Right before time slot 2, since no access category changes are needed, the access point 105 need not send a beacon. During time slot 2, contention and transmission still occur. Right before time slot 3, since a new higher priority access category enters the network, the access point 105 sends a beacon to re-adjust the access categories. During time slot 3, contention and transmission occur using the re-adjusted priorities. Right before time slot 4, since no new traffic categories enter or leave the network, the access point 105 need not send a beacon frame. During time slot 4, contention and transmission still occur. Right before time slot 5, since no new traffic categories (only currently pending traffic categories) enter the network, the access point 105 need not send a beacon frame. Dynamic adaptation according to the complex-drop model continue.

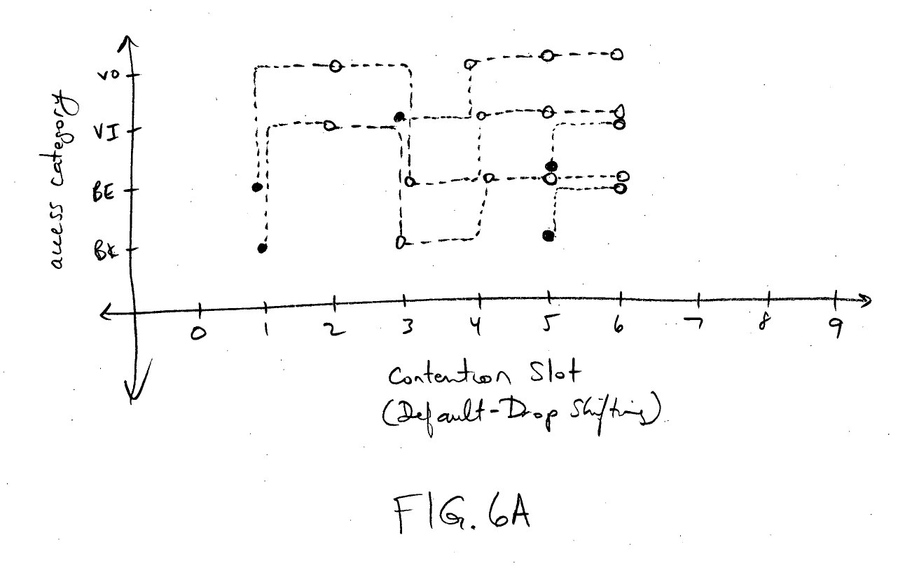

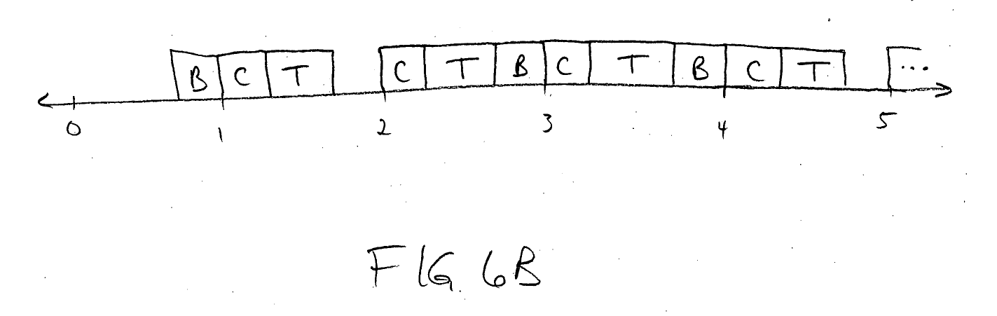

FIG. 6A is an example adaptive shifting algorithm for a default-drop shifting embodiment. According to this example, at time slot 1, the access point 105 is aware of only AC_BK and AC_BE traffic pending. Accordingly, the access point 105 sends instructions to upgrade AC_BE to AC_VO and AC_BK to AC_VI. At time slot 2, no other traffic categories enter or leave the network. Accordingly, traffic categories as adapted stay the same. At time slot 3, AC_VI enters the network. Since original AC_VI is higher priority than original AC_BK and AC_BE, the access point 105 downgrades original AC_BE (adapted to AC_VO) and original AC_BK (adapted to AC_VI) back to their default access categories. At time slot 4, no traffic categories enter or leave the network and at least one unused higher traffic category is noted as available. Accordingly, AC_VI is upgraded to AC_VO, AC_BE is upgraded to AC_VI, and AC_BK is upgraded to AC_BE. At time slot 5, another original AC_BK and original AC_BE enter the network. Since these original access categories include the same priorities as other original pending access categories, no access category change is needed. Original AC_BE remains adapted to AC_VI, and original AC_BK remains adapted to AC_BE.

Like FIG. 5A, it should be noted the example of FIG. 6A is based on traffic as noted and/or anticipated by the access point 105. As stated above, downlink traffic is noted by the access point 105 immediately. However, uplink traffic from the stations 110 to the access point 105 may not be recognized by the access point 105 until at least one time slot in the future. Accordingly, FIG. 6A is written from the perspective of the access point 105.

The algorithm of FIG. 6A is simpler, since only the upgrade portion includes adaptive analysis. The downgrade portion of the algorithm merely resumes default positions.

FIG. 6B is a timing diagram for a portion of the example adaptive shifting algorithm of FIG. 6A. According to the diagram, right before slot 1, the access point 105 sends a beacon frame (“B”) to the stations 110 (and possibly to itself) to adjust access categories. During time slot 1, the stations 110 and access point 105 contend (“C”) for the wireless medium using the adapted access categories. Then, the winning station 110 or access point 105 sends a transmission (“T”). Right before time slot 2, since no access category changes are needed, the access point 105 need not send a beacon. During time slot 2, contention and transmission still occur. Right before time slot 3, since a new higher priority original access category enters the network, the access point 105 sends a beacon to re-adjust the adapted access categories back to the default positions. During time slot 3, contention and transmission occur using the default priorities. Right before time slot 4, since unused higher traffic categories are available, the access point 105 sends a beacon frame to upgrade the original traffic categories. During time slot 4, contention and transmission still occur. Right before time slot 5, since no new traffic categories (only currently pending traffic categories) enter the network, the access point 105 need not send a beacon frame. Dynamic adaptation according to the default-drop model continue.

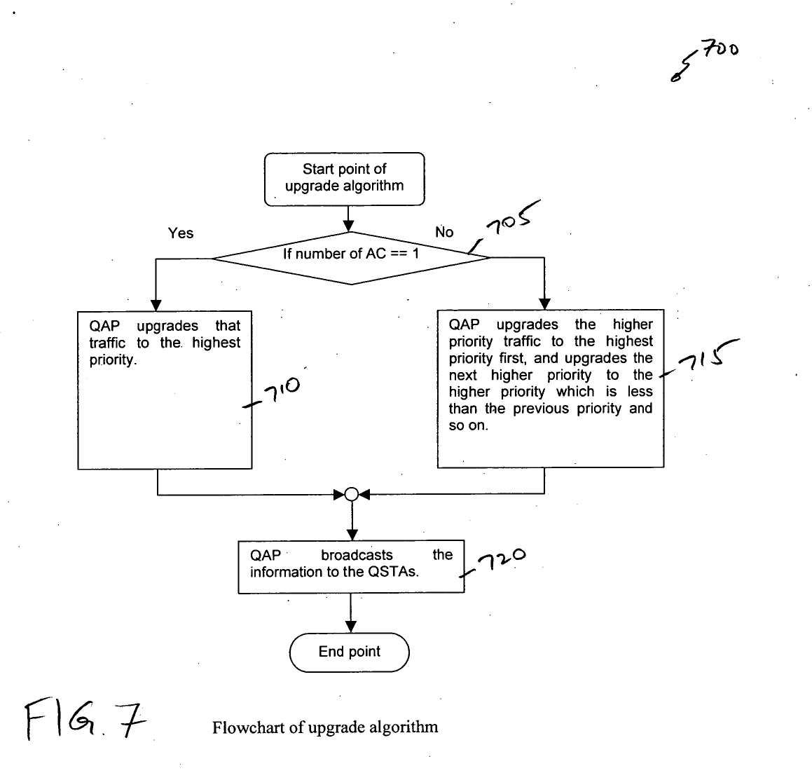

FIG. 7 is a flowchart illustrating an example upgrade method 700 in accordance with an embodiment of the present invention. Upgrade method 700 begins in step 705 by determining if the number of access categories in the network is equal to one. If so, then the access point 105 in step 710 upgrades the access category to the highest priority available. The EDCA parameters set of this access category will be the one associated with the upgraded priority. If not, then the access point 105 in step 715 upgrades the highest pending access category to the highest available access category, then upgrades the next highest pending access category to the next highest available access category, until all pending access categories are managed. The EDCA parameters set of the original access category will be the one associated with the upgraded priority. Then, the access point 105 in step 720 broadcasts the information to the stations 110. Method 700 then ends.

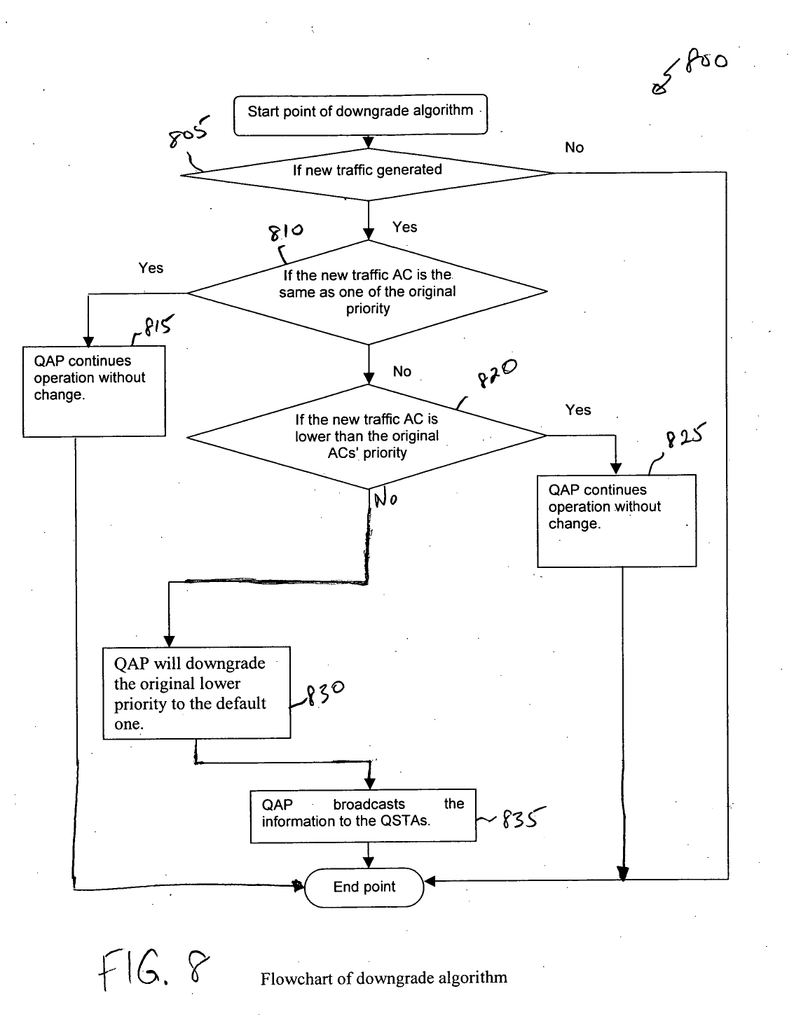

FIG. 8 is a flowchart illustrating an example downgrade method 800 in accordance with a default-drop shifting embodiment. Method 800 begins in step 805 with the access point 105 determining whether new traffic has entered the network. If no traffic has entered the network, then method 800 ends. If new traffic has entered the network, then the access point 105 in step 810 determines whether the new traffic access category is the same as one of the pending access categories. If the access category is the same as one of the pending access categories, then the access point 105 in step 815 continues operation without change. Method 800 then ends. Otherwise, if the access category is not the same as a pending access category, then the access point 105 in step 820 determines if the new traffic access category is lower than the pending access categories. If so, then the access point 105 in step 825 continues operation without change. Method 800 then ends. If the new access category is not lower than the pending access categories, then the access point 105 in step 830 determines that the entering access category must be higher than the pending access categories and downgrades the pending access categories to their default status. The access point 105 in step 835 broadcasts the downgrade instructions to the stations 110. Method 800 then ends.

Although only a particular default-drop and a particular complex-drop shifting algorithm has been described, one skilled in the art will recognize that many other variations of upgrade and downgrade algorithms are possible. Further, although the instructions have been described as being sent by beacons only when a change has occurred, one skilled in the art will recognize that beacons can alternatively be sent every time. Also, although the embodiments herein have been described as modifying the non-access-point stations 110, one skilled in the art will recognize that the upgrade/downgrade modifications could occur only in the access point 105, and not in the non-access-point stations 110. Further, although the embodiments described illustrate upgrading access categories to the highest possible access category currently unused, other embodiments may upgrade to positions less than the highest available access category. In still another embodiment, the priority management module may be located on another device in the network, and not on the access point 105.

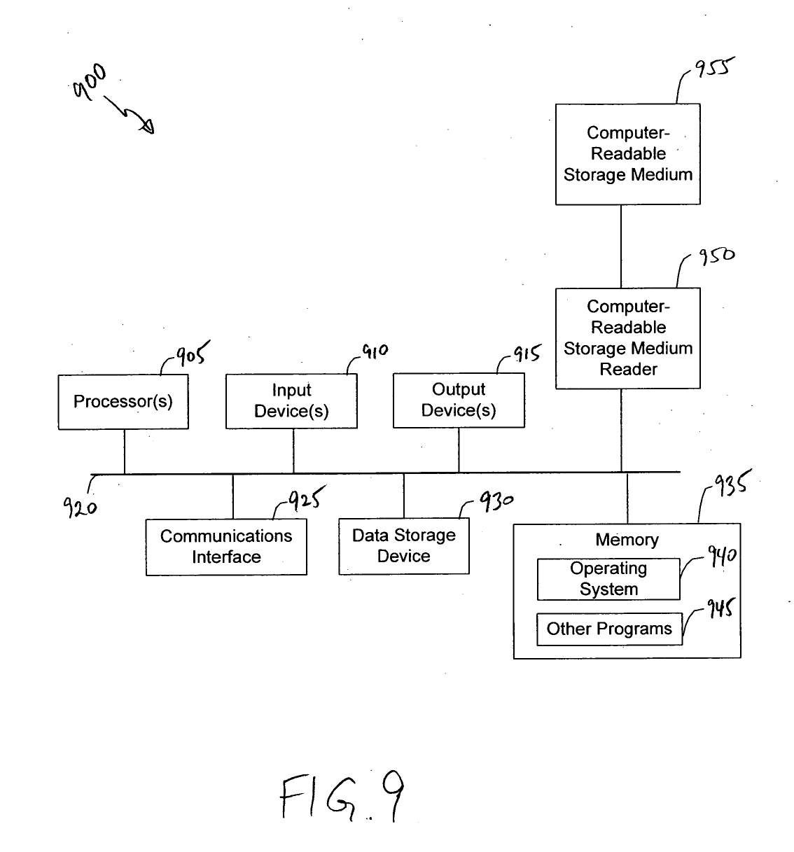

FIG. 9 is a block diagram illustrating details of an example computer system 900, of which each station may be an instance. Computer system 900 includes a processor 905, such as an Intel Pentium® microprocessor or a Motorola Power PC® microprocessor, coupled to a communications channel 920. The computer system 900 further includes an input device 910 such as a keyboard or mouse, an output device 915 such as a cathode ray tube display, a communications device 925, a data storage device 930 such as a magnetic disk, and memory 935 such as Random-Access Memory (RAM), each coupled to the communications channel 920. The communications interface 925 may be coupled to a network such as the wide-area network commonly referred to as the Internet. One skilled in the art will recognize that, although the data storage device 930 and memory 935 are illustrated as different units, the data storage device 930 and memory 935 can be parts of the same unit, distributed units, virtual memory, etc.

The data storage device 930 and/or memory 935 may store an operating system 940 such as the Microsoft Windows XP, Linux, the IBM OS/2 operating system, the MAC OS, or UNIX operating system and/or other programs 945. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 900 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 950 such as a magnetic disk drive, hard disk drive, magneto-optical reader, CPU, etc. may be coupled to the communications bus 920 for reading a computer-readable storage medium (CRSM) 955 such as a magnetic disk, a hard disk, a magneto-optical disk, RAM, etc. Accordingly, the computer system 900 may receive programs and/or data via the CRSM reader 950. Further, it will be appreciated that the term “memory” herein is intended to cover all data storage media whether permanent or temporary.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
determining whether there is an unused access category higher than a pending access category in a wireless network; and
upgrading the pending access category to use at least one MAC layer parameter of the higher access category.

2. The method of claim 1, wherein the MAC layer parameter includes a contention-based EDCA parameter.

3. The method of claim 1, wherein the MAC layer parameter includes a transmission-based EDCA parameter.

4. The method of claim 1, wherein the unused access category is the highest available access category currently unused.

5. The method of claim 1, wherein the wireless network includes at least two pending access categories and wherein the upgrading does not modify the hierarchy of the at least two pending access categories.

6. The method of claim 1, further comprising
determining whether an entering access category is higher than the pending access category; and
if the entering access category is higher than the pending access category, then downgrading the pending access category to use the at least one MAC layer parameter lower than the entering access category.

7. The method of claim 1, wherein the upgrading is implemented by modifying an EDCA parameter in the pending access category.

8. The method of claim 1, wherein the upgrading is implemented by modifying a pointer in the pending access category.

9. The method of claim 1, wherein the determining and the upgrading are performed by an access point.

10. The method of claim 1, wherein the determining is performed by an access point and the upgrading is performed by a station.

11. A system comprising:
a priority management module for determining whether there is an unused access category higher than a pending access category in a wireless network; and
an adaptive MAC layer module for upgrading the pending access category to use at least one MAC layer parameter of the higher access category.

12. The system of claim 11, wherein the MAC layer parameter includes a contention-based EDCA parameter.

13. The system of claim 11, wherein the MAC layer parameter includes a transmission-based EDCA parameter.

14. The system of claim 11, wherein the unused access category is the highest available access category currently unused.

15. The system of claim 11, wherein the wireless network includes at least two pending access categories and wherein the priority management module does not modify the hierarchy of the at least two pending access categories.

16. The system of claim 11, wherein the priority management module determines whether an entering access category is higher than the pending access category; and
wherein the adaptive MAC layer module downgrades the pending access category to use the at least one MAC layer parameter lower than the entering access category if the entering access category is higher than the pending access category.

17. The system of claim 11, wherein the adaptive MAC layer module modifies an EDCA parameter in the pending access category.

18. The system of claim 11, wherein the adaptive MAC layer module modifies a pointer in the pending access category.

19. The system of claim 11, wherein the priority management module and the adaptive MAC layer module are in an access point.

20. The system of claim 11, wherein the priority management module is in an access point and the adaptive MAC layer module is in a station.

21. A system, comprising:
means for determining whether there is an unused access category higher than a pending access category in a wireless network; and
means for upgrading the pending access category to use at least one MAC layer parameter of the higher access category.

22. A method comprising:
determining whether there is an unused access category higher than a pending access category in a wireless network;
upgrading the first pending access category to the higher access category;
determining whether an entering access category entering the wireless network is higher than the pending access category; and
if the entering access category is determined as higher than the pending access category, then downgrading the pending access category to an access category lower than the entering access category.

23. The method of claim 22, wherein the downgrading includes downgrading the pending access category back to its default access category.

24. The method of claim 22, further comprising:
determining whether the entering access category is the same as the pending access category; and
if the entering access category is determined to be the same as the pending access category, then maintaining the access categories as upgraded.

25. The method of claim 22, further comprising:
determining whether the entering access category is lower than the pending access category; and
if the entering access category is determined to be lower than the pending access category, then maintaining the access categories as upgraded.

26. The method of claim 22, further comprising:
determining whether the entering access category is lower than the pending access category; and
if the entering access category is determined to be lower than the pending access category, then upgrading the entering access category to the highest unused access category.

27. The method of claim 22,
wherein at least two different pending access categories are pending in the network; and
further comprising
determining whether one of the two pending access categories has left the network;
if one of the pending access categories has left the network, then determining whether the access category now unused is higher than any pending access category; and
if one of the access category now unused is determined to be higher than one of the pending access categories, then upgrading the one pending access category.
